(19) United States
(12) Patent Application Publication
(10) Pub. No.: US 2008/0130209 A1
(43) Pub. Date: Jun. 5, 2008

(54) CALCULATOR LETTER OPENER

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,199

(22) Filed: Dec. 1, 2006

(51) Int. Cl. G06F 1/16

(52) U.S. Cl. 361/681; 361/686

(57) ABSTRACT

A multi-office-function assembly incorporating commonly used desktop utilities such as a handheld calculator, a tape flag dispenser, letter opener, a note pad storage, a digital clock, a mirror, or a picture frame. The assembly includes a base housing, an input housing hingedly connected to an upper surface of the base housing to rotate between substantially flat and pop-up positions, an electric calculator having an input unit and electronic circuitry disposed preferably in the input housing, and a display unit disposed preferably in a top housing formed on the base housing. The assembly also includes a motorized letter opener disposed preferably in the top housing, a tape flag dispenser and a note pad storage disposed in the base housing, a digital clock, and a picture frame or a mirror disposed in the input housing.

### FIELD OF THE INVENTION

The present invention relates to field of a multi-office-function assembly including a calculator, a tape flag dispenser, letter opener, a note pad storage, a digital clock, and a picture frame.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Handheld calculators and desktop picture frames are widely used almost as indispensable desktop accessories in business offices, houses, or other living spaces. Besides those, other desktop utilities such as a digital alarm clock, letter opener, sticky notes, and flag tapes are also commonly used in various office settings. These utilities, usually used separately, are often easily misplaced and tend to disorder working spaces on a desk. Therefore, if two or more of such office utilities can be integrated on a single multi-function assembly, it would provide for a user not only the ease and convenience of using several office functions at will, but also the advantage of saving desktop spaces, and thereby, permitting larger desktop working space. Further, a neat integration of such office utilities would contribute, as a part of office decoration, to enhancing the aesthetics of work environment

Some of the prior art appears to disclose combining some of office desktop utilities, but not in the same way as the present invention. U.S. Pat. No. 5,989,173 discloses a multi-functional assembly incorporating several office utilities such as a calculator, a digital clock, a letter opener, a paper tray, and a roll tape dispenser. This reference, however, does not teach further combining a picture frame or a dispenser of flag tapes which are commonly used for tagging or marking pages of books for quick reference later. U.S. Pat. No. 4,478,330 discloses a portable pocket size container that includes a calculator, a picture frame, a digital clock, a note pad, and other office or household accessories. But, the invention of this reference would be relatively costly in manufacturing due to its rather multi-fold structure needed for retaining a considerable number of different types of accessories, and further, it fails to teach incorporation of the widely used desktop utilities such as a letter opener or a flag tape dispenser.

Therefore, it would be desirable to provide a multi-function assembly that carries a combination or sub-combination of most frequently used office desktop utilities or accessories such as a calculator, a tape flag dispenser, letter opener, a note pad storage, a digital clock, and a picture frame, while demanding relatively simple structure and manufacturing cost. Moreover, it would be desirable it such desktop multi-function assembly can provide, with all the utilities aforementioned, a neat and compact appearance as well, and even some space thereon to place advertising materials for advertisement.

### SUMMARY OF THE INVENTION

The present invention provides a low-cost multi-office-function desktop assembly incorporating commonly used desktop utilities such as a handheld calculator, a tape flag dispenser, letter opener, a note pad storage, a digital clock, a mirror, or a picture frame.

The multi-office-function assembly made in accordance with the present invention is largely comprised of an assembly housing; an electric calculator comprising an input unit, such as push buttons, attached to the assembly housing for inputting instructions to the calculator, electronic circuitry encased within the assembly housing for reading the instructions, computing mathematical calculations following the instructions, and generating output results, and a display unit, such as a LCD, attached to the assembly housing for displaying the output results; and a combination of office utilities among a tape flag dispenser, letter opener, a note pad storage, a digital clock, and a picture frame.

The assembly housing may comprise a base housing having a flat lower surface for resting on an external surface and an input housing hingedy connected to an upper surface of the base housing such that it may assume two positions, substantially flat and substantially erect pop-up positions. Preferably, the electric circuitry and input unit may be disposed in the input housing. The input housing may be further disposed within a recess defined on the upper surface of the base housing. The recess may be deep enough to operate as a note pad storage beneath the input housing. Moreover, the base housing may further comprise a top housing formed on the upper surface thereof adjacent the input housing for carrying the display unit, and preferably, a letter opener which may be motorized for automatic opening of envelopes. A picture frame or a mirror may be formed on the bottom surface thereof, opposite the top surface where the input unit is formed, and the flag tape dispenser may be disposed on a side surface of the base housing.

One of the advantages of the present invention is to provide for a user the ease and convenience of using several office functions by structurally and functionally integrating them into a single multi-function assembly. Other advantages of such integration of desktop utilities are saving of desktop spaces, larger desktop working spaces available, and consequentially, enhancement in work efficiency. Anther advantage is, owing to the neat and compact appearance of the multi-function assembly, enhancing aesthetics of office working environment.

Lastly, the present invention provides an effective means for advertising and promotion. Since the multi-office-function assembly would be accessed and used more frequently by a user and more likely to attract attentions of other viewers owing to its neatly integrated multiple utilities, it can be an effective vehicle for advertisement as well, whereby advertising materials can be permanently imprinted on any outer surface thereof.

### BRIEF DESCRIPTION OF THE DRAWINGS

FIG. 1 is a perspective view of the office function assembly made according to the present invention with an input housing in a flat position;

FIG. 2 is a top plan view of the office function assembly made according to the present invention;

FIG. 3 is a perspective view of the office function assembly made according to the present invention with the input housing in a pop-up position, displaying a picture frame;

FIG. 3A is a perspective view of the office function assembly illustrating a picture exploded from the picture frame; and

FIG. 4 is a side elevational view of the office function assembly with the input housing in the flat position.

### DETAILED DESCRIPTION OF THE INVENTION

The present invention generally relates to a multi-function office desktop assembly including a handheld calculator and a combination or sub-combination of other office utilities such as a tape flag dispenser, letter opener, a note pad storage, a digital clock, a mirror, or a picture frame. Several preferred embodiments of the present invention will now be described with reference to FIGS. (‘FIGS.’) 1-5, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

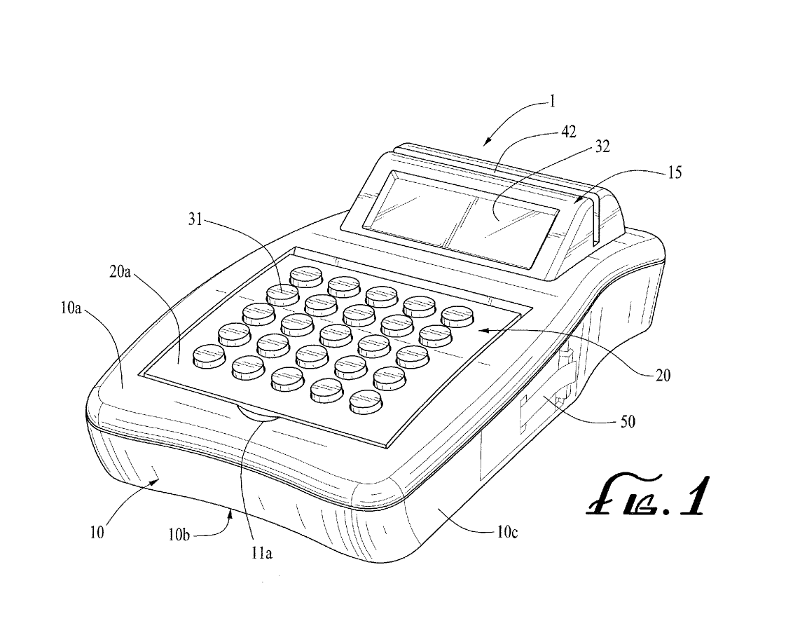

Now referring to FIGS. 1-4, the multi-function desktop office assembly 1 comprises, in the preferred embodiment of the present invention, a base housing 10, an input housing 20, an electric calculator comprising electric circuitry (not shown), an input unit 31, and a display unit 32, and office functions such as a tape flag dispenser 50, letter opener 40, a recess 11 for storing note pads or the like, a digital clock (not shown), and a picture frame 21.

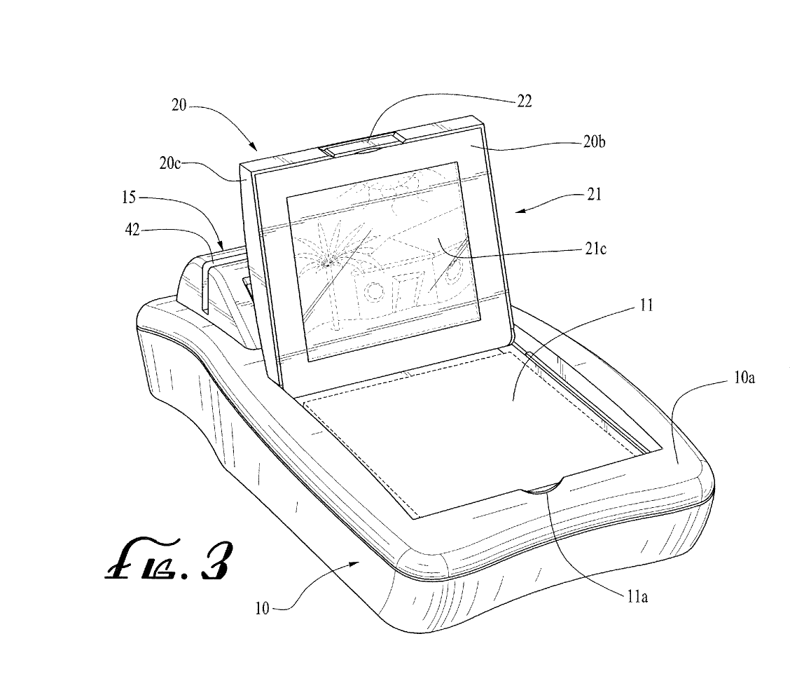

The base housing 10, generally in a shape of a rectangular box roughly of a size of an adult hand, has an upper surface 10a that is generally planar, a lower surface 10b that is preferably flat for resting on an external surface such as a desk or table top, and side surfaces 10c. The input housing 20, in a shape of, preferably, a rectangularly shaped box, has substantially flat top surface 20a, bottom surface 20b, and side edges 20c. In the preferred embodiment, a recess 11 sized and configured to receive the input housing 20 is defined on the upper surface 10a of the base housing 10, preferably in the lower half region thereof, and within the recess 11, the input housing 20 is pivotally connected at an edge thereof to the base housing 10. In the preferred embodiment, such pivotal connection may be implemented via two pivotal pins (not shown) respectively connecting an edge of the recess 11 to the adjoining side edge 20c of the input housing 20 as shown in FIG. 3. But other methods of pivotal connection recognized by the one in the art may also be used. Through the pivotal connection, the input housing 20 may rotate between two positions; a flat position in which the top surface 20a of the input housing 20 is substantially parallel to the upper surface 10a of the base housing 10 as shown in FIGS. 1, 2, and 4, and a pop-up position in which the input housing 20 stands substantially perpendicular to the upper surface 10a of the base housing 10 as shown in FIG. 3. The input housing 20 may be easily pivotally lifted up out of the recess 11 to reach the pop-up position by using the thumb notch 11a as shown in FIG. 1.

The recess 11 is, preferably, at least deep enough to have the top surface 20a of the input housing 20 lies, in the flat position, substantially coplanar with the upper surface 10a of the base housing 10. Moreover, the recess 11 may be further extended below the input housing 20 to define a compartment with a flat bottom for storing therein a note pad, sticky notes, other kinds of papers, clips, pins, staples, or the like, which can be easily accessed by rotating the input housing 20 out to the pop-up position as shown in FIG. 3.

The electric calculator is a commonly used hand calculator. The input unit 31 for inputting instructions and numeral values with which the calculator would operate may be the typical alphanumeric push button keys used for common hand calculators, with imprinted symbols for numerals and arithmetic operations to be performed by the calculator, but it could be other kinds of input method known to those skilled in the art, such as touch pads. The electronic circuitry for reading such inputted instructions and numeral values, carrying out the mathematical calculations instructed, and generating output results which consist, for a typical hand calculator, exclusively of numbers and arithmetic symbols is well known to those skilled in the art, and thus, not described herein further. Preferably, the electric circuitry is encased within the input housing 20 and the input unit or the push button keys 31 are arrayed on the top surface 20a of the input housing 20 as shown in FIGS. 1-4. For supplying power for that, a battery compartment having a thumb notched cover 22 may be formed on one of the side edges 20c of the input housing 20 as shown in FIG. 3. But in another embodiment, the electric circuitry could be encased within the base housing 10 instead, and the power may be supplied from a separate battery compartment (not shown) formed in the base housing 10, for example, on the lower surface 10b thereof.

The display unit 32, necessarily electrically connected to the electric circuitry, is configured to display the output results generated by the electric circuitry and may comprise, in the preferred embodiment, a well known LCD panel. The electric circuits and method for displaying the output results, which is in the form of digital signals, through the LCD are well known in the art, and thus, not further described here. The present invention also contemplates other display means well-recognized by those skilled in the art, such as LED or even a paper tape. Preferably, the display unit 32 is disposed on the upper surface 10a of the base housing 10 in the upper half region thereof above the input housing 20. In the preferred embodiment, the base housing 10 may further comprise a top housing 15 formed on the upper surface 10a adjacent the upper edge thereof as shown in FIGS. 1, 3, and 4, and the display unit, or the LCD 32 may be located thereon. In the preferred embodiment where the electric circuitry is encased with the input housing 20 which is pivotally connected to the base housing 10, the required connection between the electric circuitry and the display unit 32 may be established by a wire contained in the pivotal pins.

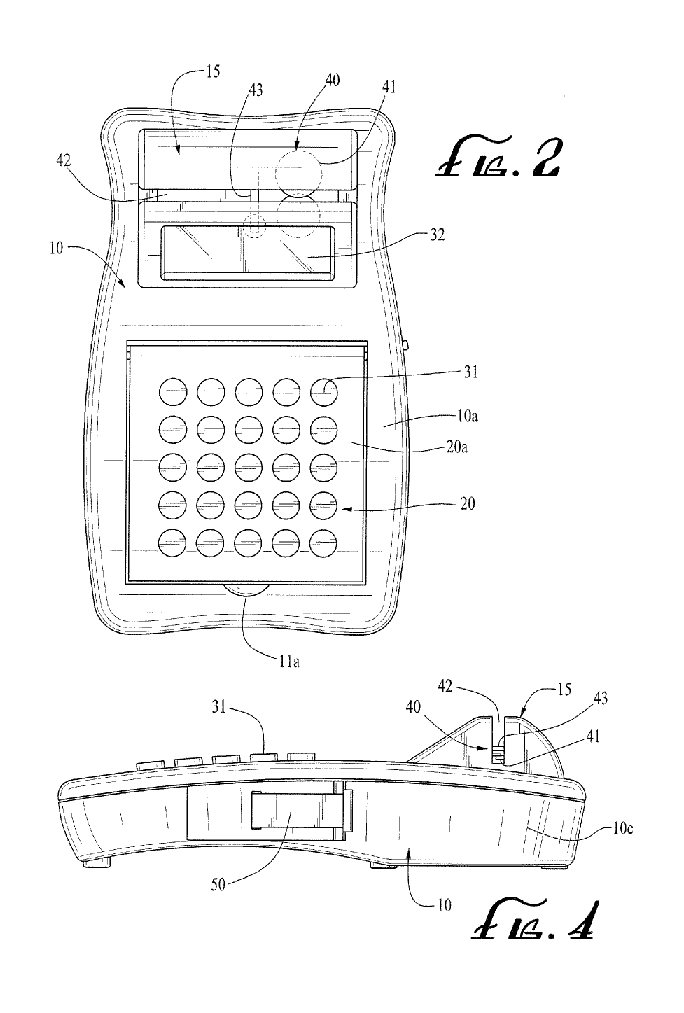

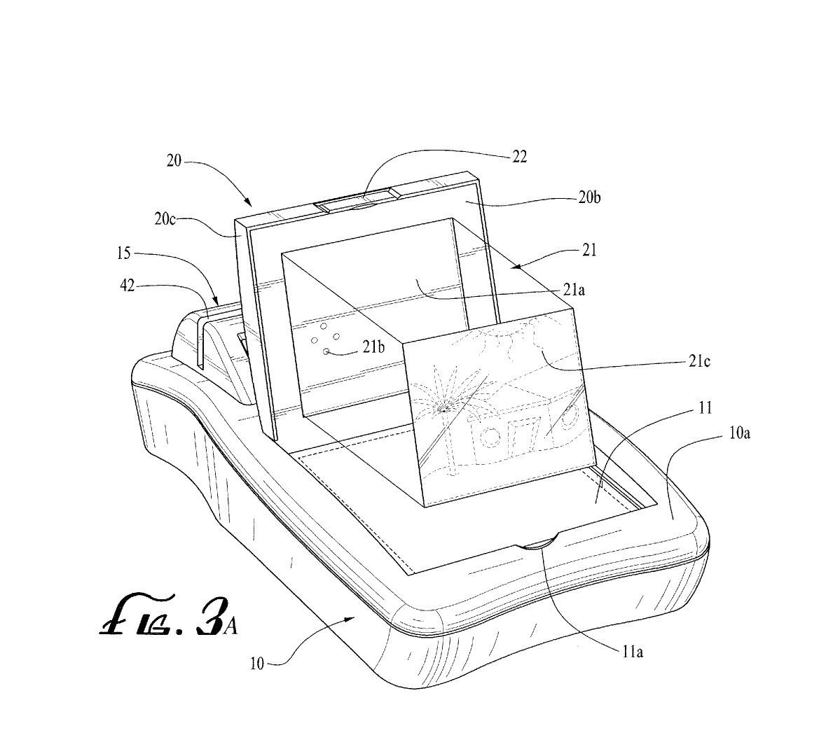

The multi-function desktop office assembly 1 in the present invention may further comprise a letter opener 40, which may be motorized to automatically cut the edge of an envelope that is engaged against it. In the preferred embodiment, the motorized letter opener 40 is located at the bottom of a transverse slit 42 defined in the top housing 15 as shown in FIGS. 2 and 4, where an envelope is opened by the opener 40 as it slides through the slit 42. More specifically in the preferred embodiment, the motorized letter opener 40 comprises a switch 43 and a pair of circular envelope-cutting toothed blades 41 as described in the dotted lines in FIG. 2. As an envelope is inserted into and slides across the slit 42 toward the opener 40, it pushes the switch 43, triggering the two circular cutting blades 41 to rotate, and as it further slides between the two rotating blades 41, the envelope is cut and opened. The detailed structure and mechanism of such motorized letter opener is well known to those skilled in the art. Like the electric calculator, the power for the motorized letter opener 40 may be supplied from batteries contained in the compartment (not shown) formed in the base housing 10, either on the side surfaces 10c or lower surface 10b thereof. In other embodiments, other kinds of motorized, or traditional non-motorized letter openers recognized by those skilled in the art are also within the contemplation of the present invention, which may be formed either in the top housing 15 or other sections of the base housing 10.

The flag tape dispenser 50 for storing and feeding typical adhesive flag tapes used for tagging book pages is disposed, preferably, on one of the side surfaces 10c of the base housing 10, as shown in FIGS. 1, 2 and 4, on which a compartment having a removable lid may be formed to retain the flag tape dispenser 50 therein and the flag tapes may be fed through a feeding slit defined on the lid.

The office assembly 1 in the present invention may also incorporate a picture frame 21, which is formed, in the preferred embodiment, on the bottom surface 20b of the input housing 20 so that it may be accessed for view and replacement of graphic images in a paper format such as a picture or photo when the input housing 20 is in the pop-up position as shown in FIG. 3. In the preferred embodiment, the bottom surface 20b of the input housing 20 may define thereon a slightly recessed area 21a, as shown in FIG. 3A, on which the picture may be frictionally retained under a detachable transparent cover 21c employed for its protection. In another embodiment, the picture may be replaceably attached to the recessed area 21a by a variety of common attachment means such as pins, clips, clamps, adhesives, scotch tapes, or double-sided tapes, or via grooves defined along the edge of the recessed area. In still another embodiment (not shown), the input housing 20 may comprise a picture compartment formed within the input housing and a picture-inserting slit defined at, for instance, one of side edges 20c of the input housing 20 through which the picture can be inserted into or taken out of the compartment for replacement. In this embodiment, a display window connected to the compartment may be defined, preferably, on the surface 20b through which the picture in the compartment is viewed. In yet another embodiment (not shown), a mirror, instead of a picture frame, may be formed on the bottom surface 20b of the input housing 20.

In addition, the multi-function desktop office assembly 1 in the present invention may further comprise a typical digital alarm clock (not shown) encased within either the base housing 10 or the input housing 20. The clock and the electric circuitry for the calculator may be configured such that while the calculator is not used, the display unit 32 may keep displaying the time information generated from the digital alarm clock. In the preferred embodiment, the alarm sound may be emitted from tiny alarm speakers 21b defined on the recessed area 21a of the picture frame 21, being hidden under the graphic image as shown in FIG. 3A.

The base housing 10, the input housing 20, and the top housing 15 are fabricated, preferably, of plastic material. But they may be manufactured from any other suitable rigid or semi-rigid material well known to the one skilled in the art, including but not limited to, wood, metal, cardboard, polymeric compositions, fiberglass, hardboard, or other synthetic materials. Further, their overall shape is not restricted to an elongated rectangular box as shown in FIGS. 1-5 in the preferred embodiment, but can be other geometrical shapes without departing from the spirit of the invention.

Lastly, the present invention also provides an effective method for advertising and promotion. Since the multi-function desktop office assembly in the present invention is likely to be accessed and used more frequently by a user and attract the attention of the user and viewers owing to its integrated multiple functionality and compact, attractive appearance, it can be an effective vehicle for advertisement, whereby advertising material may be permanently imprinted on any outer surface of the desktop office assembly. FIGS. 1 and 3 show advertising material 60 imprinted on the upper surface 10a of the base housing 10. But such advertising material may be placed on any other surface of the office assembly 1.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. An office function assembly for opening envelopes, dispensing tape flags, and performing calculations, the assembly comprising:
an assembly housing;
a calculator comprising:
an input unit attached to the assembly housing for inputting instructions to the calculator;
electronic circuitry encased within the assembly housing and configured to receive the instructions, to compute mathematical calculations, and to generate output results, and
a display unit attached to the assembly housing for displaying the output results;
a letter opener disposed in the assembly housing for opening the envelope engaged to the opener; and
a tape flag dispenser disposed in the assembly housing for dispensing the tape flags.

2. The office function assembly of claim 1, wherein the assembly housing comprises a base housing having a lower surface for resting on a planar surface and an opposing upper surface, and an input housing disposed on an upper surface of the base housing, the input unit and the electric circuitry being disposed in the input housing.

3. The office function assembly of claim 2, wherein the input housing is hingedly connected to the upper surface of the base housing.

4. The office function assembly of claim 3, further comprising a compartment defined in the base housing below the input housing sized and configured to receive self-sticking notepads therein.

5. The office function assembly of claim 2, wherein the tape flag dispenser is defined by a side portion of the base housing.

6. The office function assembly of claim 1, wherein the letter opener includes an electric motor and a pair of blades connected thereto for slicing envelopes therewith.

7. The office function assembly of claim 1, wherein the display unit comprises a LCD.

8. The office function assembly of claim 1, wherein the assembly housing comprises a top housing protruding from the upper surface thereof, in which the display unit is disposed.

9. The office function assembly of claim 8, wherein the display unit comprises a LCD.

10. The office function assembly of claim 8, wherein the letter opener is disposed in the top housing adjacent the display unit.

11. The office function assembly of claim 10, wherein the letter opener includes an electric motor and a pair of blades connected thereto for slicing envelopes therewith.

12. The office function assembly of claim 8, wherein the input unit is formed on the upper surface of the assembly housing adjacent the top housing.

13. The office function assembly of claim 1, wherein the input unit includes depressable buttons.

14. The office function assembly of claim 1, further comprising a digital clock encased within the hosing assembly wherein time information generated by the clock is displayed on the display unit when the output results are not displayed thereon.

15. The office function assembly of claim 1, wherein the electric circuitry is further configured such that the output results generated thereby consist exclusively of numbers and symbols for arithmetic calculations.

16. An office function assembly comprising:
an assembly housing comprising:
a base housing having a lower surface and an opposing upper surface, the base housing having a recess defined on the upper surface thereof and
an input housing disposed within the recess and hingedly connected to the upper surface of the base housing, the input housing having opposing top and bottom surfaces, roximal to the upper and lower surfaces of the base housing respectively;
a calculator comprising:
an input unit attached to the assembly housing for inputting instructions to the calculator,
electronic circuitry encased within the assembly housing and configured to receive the instructions, to compute mathematical calculations, and to generate output results;
a display unit attached to the assembly housing for displaying the output results; and
a picture frame formed on the bottom surface of the input housing,
wherein the input housing is positionable between a flat position aligning the top surface of the input housing substantially coplanar with the upper surface of the base housing and a pop-up position extending the input housing out of the recess for displaying the picture frame and providing access to the recess.

17. The office function assembly of claim 16, wherein the input unit and the electric circuitry are disposed in the input housing.

18. The office function assembly of claim 16, wherein the recess extends below the bottom surface of the input housing for storing therein papers.

19. The office function assembly of claim 16, wherein the input unit includes depressable buttons.

20. The office function assembly of claim 16, further comprising a digital clock encased within the housing assembly wherein time information generated by the clock is displayed on the display unit when the output results are not displayed thereon.

21. The office function assembly of claim 16, wherein the display unit comprises a LCD.

22. The office function assembly of claim 16, wherein the electric circuitry is further configured such that the output results generated thereby consist exclusively of numbers and symbols for arithmetic calculations.

23. The office function assembly of claim 16, further comprising a letter opener having an electric motor and a pair of blades connected thereto for slicing envelopes therewith, a motorized letter.

24. The office function assembly of claim 23, further comprising a top housing protruding from the upper surface of the base housing, in which the display unit is disposed.

25. The office function assembly of claim 24, wherein the display unit comprises a LCD.

26. The office function assembly of claim 24, wherein the letter opener is disposed in the top housing.

27. The office function assembly of claim 24, wherein the input unit is formed on the upper surface of the assembly housing adjacent the top housing.

28. The office function assembly of claim 16 further comprising a tape flag dispenser disposed in the assembly housing.

29. A method of advertising comprising the steps of:
(a) providing an office function assembly for opening envelopes, dispensing tape flags, and performing calculations, the assembly comprising:
an assembly housing;
a calculator comprising:
an input unit attached to the assembly housing for inputting instructions to the calculator;
electronic circuitry encased within the assembly housing and configured to receive the instructions, to compute mathematical calculations, and to generate output results, and
a display unit attached to the assembly housing for displaying the output results,
a letter opener disposed in the assembly housing for opening the envelope engaged to the opener, and
a tape flag dispenser disposed in the assembly housing for dispensing the tape flags; and
(b) disposing advertising material on a visible outer surface of the assembly.
